(19) United States
(12) Patent Application Publication
(10) Pub. No.: US 2019/0073837 A1
(43) Pub. Date: Mar. 7, 2019

(54) A PARKING METER DEVICE

(71) Applicant: GLOBAL INTEGRATED SOLUTIONS LIMITED, Auckland (NZ)

(72) Inventor: Mark OLIVER, Auckland (NZ)

(21) Appl. No.: 16/065,960

(22) PCT Filed: Dec. 12, 2016
(86) PCT No.: PCT/NZ2016/050197

§ 371 Date: Jun. 25, 2018

(30) Foreign Application Priority Data
Jan. 8, 2016 (NZ) 715814

(51) Int. Cl. G07B 15/02; G06Q 20/34; G06Q 20/32; G07F 17/24

(52) U.S. Cl. CPC G07B 15/02; G07F 17/248; G06Q 20/322; G06Q 20/352

(57) ABSTRACT

The invention provides a compact, coinless, ticketless parking meter device which includes a timer means; a payment facilitating arrangement operable in cooperation with a non-cash payment instrument for effecting payment of a monetary amount for a parking period; a display means for displaying a balance remaining of the parking period; and a power supply unit for supplying power to the timer means, the payment facilitating arrangement and the display means.

### FIELD OF INVENTION

This invention relates to a parking meter device, and in particular to a coinless parking meter device.

### BACKGROUND

Various parking meters are known, such as those described in U.S. Pat. No. 7,854,301 and U.S. Pat. No. 8,595,054. These parking meters describe parking meters that include coin operated functionality. Coin operated parking meters require semi-regular visits by personnel trained in security and who can collect the coins and carry cash from one or more parking meters. The need for personnel to collect coins from such devices adds security risks for those personnel who are in possession of large numbers of coins collected from parking meters.

Other parking meters require a ticket to be printed and dispensed from the meter that is then displayed on the dashboard of the car. The ticket shows the time of expiry of the paid period and parking wardens visit each car to view the ticket displayed. Having a parking meter dispense paper tickets/receipts is problematic because each parking meter must be visited on a semi regular basis to replace the roll of ticket tape and or receipts. If the parking meter runs out of paper the parking meter is no longer useful because a ticket must be dispensed to show the valid parking period.

It is an object of the invention to overcome these difficulties or to at least provide the public with a useful choice.

### SUMMARY OF INVENTION

In accordance with the invention there is provided a compact, coinless, ticketless parking meter device which includes
a timer means;
a payment facilitating arrangement operable in cooperation with a non-cash payment instrument for effecting payment of a monetary amount for a parking period;
a display means for displaying a balance remaining of the parking period; and
a power supply unit for supplying power to the timer means, the payment facilitating arrangement and the display means.

In one embodiment, the payment facilitating arrangement is a card reading means, for reading information and data on the card. The card may have a magnetic strip or a chip.

In one embodiment, the card reading means is a contactless card reader.

In one embodiment, the timer means is a clock chip, which is included in a central process controller.

In another embodiment, the card reading means is a card reader having an access slot into which the card is inserted to read the information and data on the card.

In one embodiment, the parking meter device includes an alpha-numeric or numeric keypad.

In one embodiment, the parking meter device includes a contactless card reader and a card reader having an access slot into which the card is inserted to read the information and data on the card.

In one embodiment, the parking meter device includes a camera that may take photos of a proximate parking bay.

In one embodiment, the parking meter device is for use in a multi-parking bay situation and includes pay by space or pay by car number plate functionality.

In one embodiment, the power supply unit sources power from a solar panel.

In one embodiment, the parking meter device includes indicator means, such as one or more light emitting diodes that show the status of the device. The status of the device may for example show that the parking period is current or that the parking period has expired.

The payment facilitating arrangement may further have a wireless banking information transmitting means for transmitting financial transaction data to a banking system in order to debit the appropriate account, as determined from the card, and credit the account of the parking operator. The banking information transmitting means may operate in an on-line or off-line manner. It may use a cellular telephone network such as CDMA or GSM, or Wi-Fi and IP Embedded Wireless.

In one aspect of the invention, the payment facilitating arrangement has a wireless purse communicating means for communicating with an electronic purse, in accordance with any suitable protocol, whereby an appropriate amount may be deducted from the value stored in the purse, such as a Snapper™, HOP™, Beijing Transit card or an OTM card. The banking information transmitting means will then be operable to credit the account of the parking operator with the amount by which the purse was decreased.

In another aspect of the invention, the parking meter device may have a payment facilitating arrangement for receiving an instruction and payment from a cellular telephone.

The parking meter device may have a solar power charging arrangement whereby the power supply unit is recharged by solar energy. The parking meter device may also have a power management facility.

As a further feature, the parking meter device may have a locating arrangement for determining the location of the parking meter device. The locating arrangement may be GPS operable.

The parking meter device may have a management communication arrangement for communicating management information to a management centre or a parking warden. For example, such management information may include malfunction details, a tampering alert, duration expiration and the location of the parking meter device.

The display means may also display that the parking time paid for has expired.

The parking meter device may have a selection means for selecting the duration of parking time required and the appropriate cost thereof, whereby a person wishing to park may select the desired time duration.

The invention extends to a method of controlling parking in a single or multiple parking bay, which includes accepting payment for parking in the bay by means of a credit or debit card account, from an electronic purse, or by means of a cellular telephone using the parking device as defined above.

If payment is effected by means of a credit or debit card account, the method may include transmitting data in a wireless manner to a first financial institution to debit an account of the parker and a second financial institution to credit the account of a parking operator.

If payment is effected from an electronic purse, the method may include transmitting financial data in a wireless manner with the first financial institution to debit an account of the purse administrator and with the second financial institution to credit the account of the parking operator.

Similarly, if payment is effected by means of a cellular telephone, the method may include receiving an authorisation signal, such as an SMS message, that payment for the parking has been made. This signal may also be provided by the second financial institution or from a control centre.

The method of controlling parking may include sensing if a vehicle is parked in the bay when the paid for parking time has expired or the maximum parking time has been exceeded and transmitting a time expired signal to a management centre or a parking warden. A location signal, providing the location of the bay, may also be transmitted.

### BRIEF DESCRIPTION OF THE DRAWINGS

The invention is now described, by way of a non-limiting example, with reference to the accompanying drawings, in which:

FIG. 1(a) shows a perspective front view of a parking meter device in accordance with the invention.

FIG. 1(b): shows a cross-sectional side view of the parking meter device in accordance with the invention.

FIG. 2(a): shows a further perspective front view of a parking meter device in accordance with the invention.

FIG. 2(b): shows a still further perspective front view of a parking meter device in accordance with the invention.

FIG. 2(c): shows a further perspective rear view of a parking meter device in accordance with the invention.

FIG. 3(a): shows a rear perspective right side view of a parking meter device in accordance with the invention, with its rear cover removed.

FIG. 3(b): shows a rear perspective left side view of a parking meter device in accordance with the invention, with its rear cover removed.

FIG. 3(c): shows a side view of a parking meter device in accordance with the invention, with its rear cover removed.

FIG. 3(d): shows a rear view of a parking meter device in accordance with the invention, with its rear cover removed.

FIG. 4(a): shows a front view of a parking meter device in accordance with the invention.

FIG. 4(b): shows a cross-sectional side view of the parking meter device in accordance with the invention, the cross-section taken through line A shown in FIG. 4(a).

FIG. 5: shows a perspective exploded view of the components of the parking meter device in accordance with the invention.

### DETAILED DESCRIPTION OF THE INVENTION

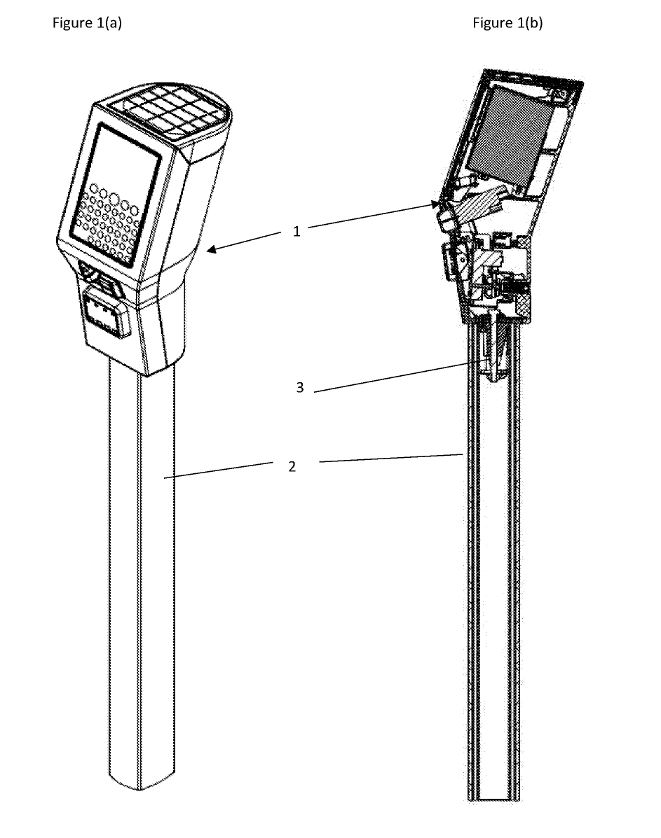

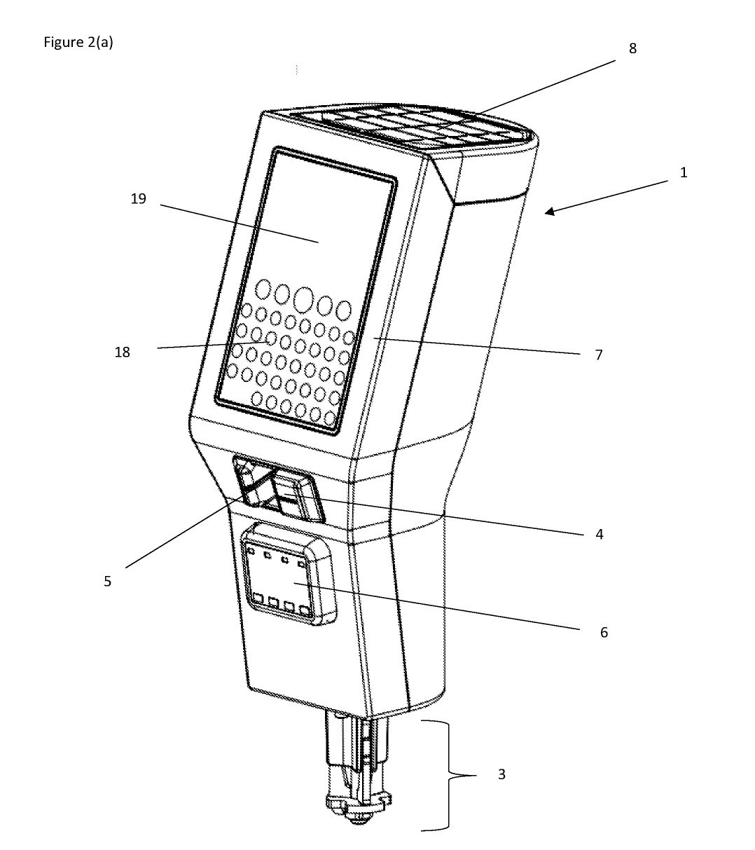

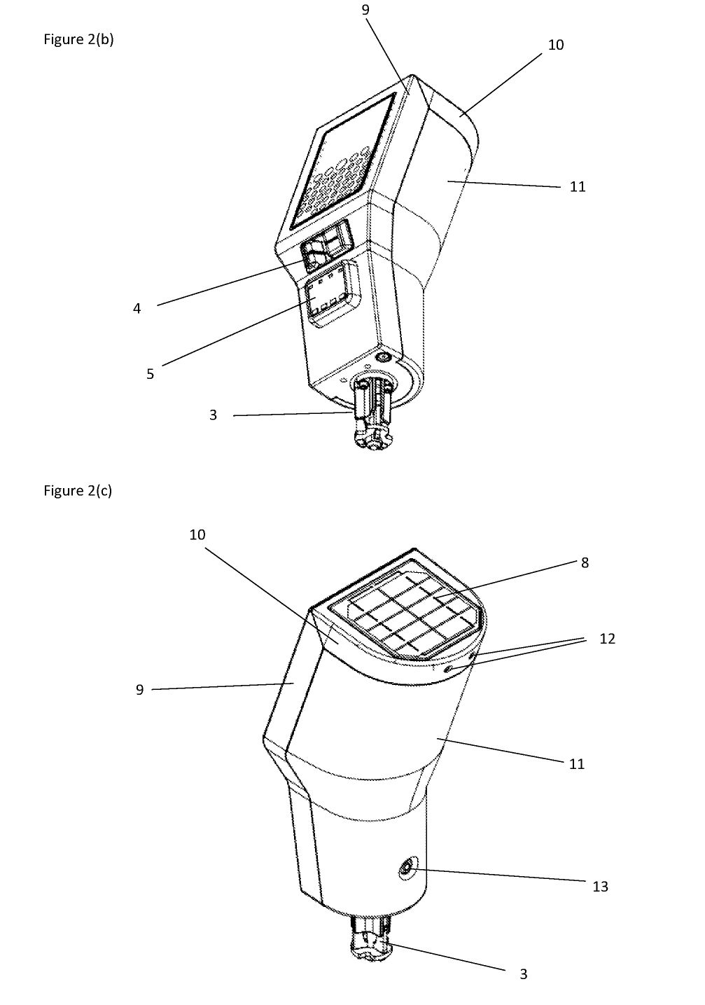

Referring to the drawings, and in particular FIGS. 1 and 2, a coinless parking meter device 1 in accordance with the invention is shown on a lower base support 2. The parking meter device 1 is for a single or multiple bay parking meter. The parking meter device 1 preferably has a lower attachment mechanism 3 (best seen in FIGS. 2(a) and 2(b)) to allow for the retro-fitting to existing parking meter base supports, such as a two inch galvanised pipe meter pole. The lower attachment mechanism 3 shown is a wedge lock pole mounting system, which is best illustrated in FIG. 1b.

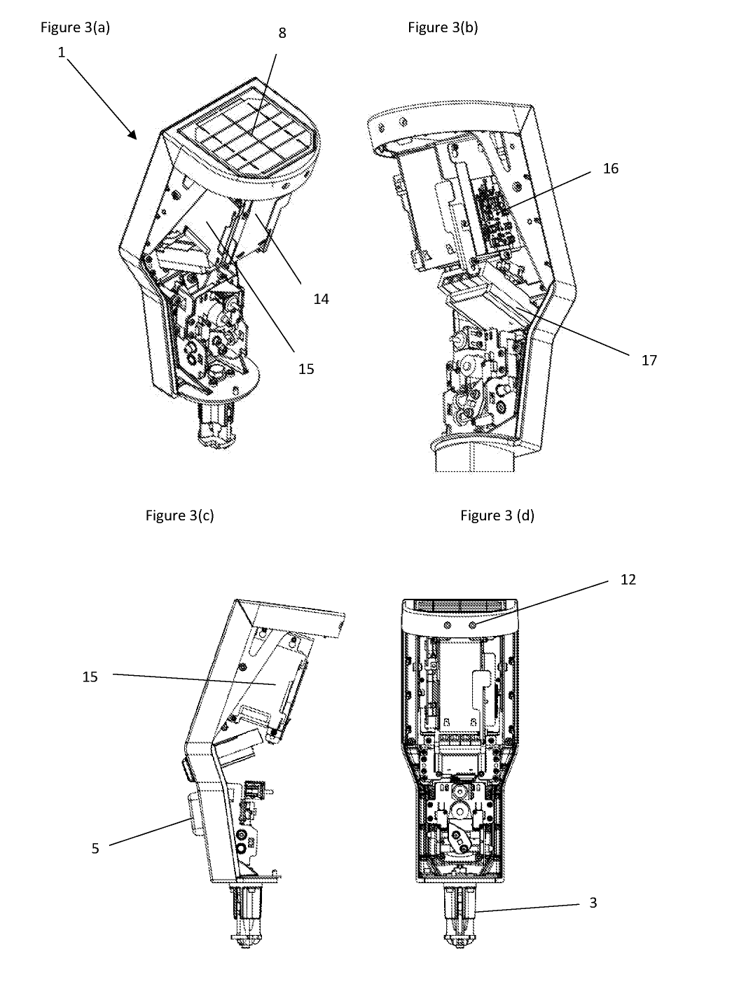

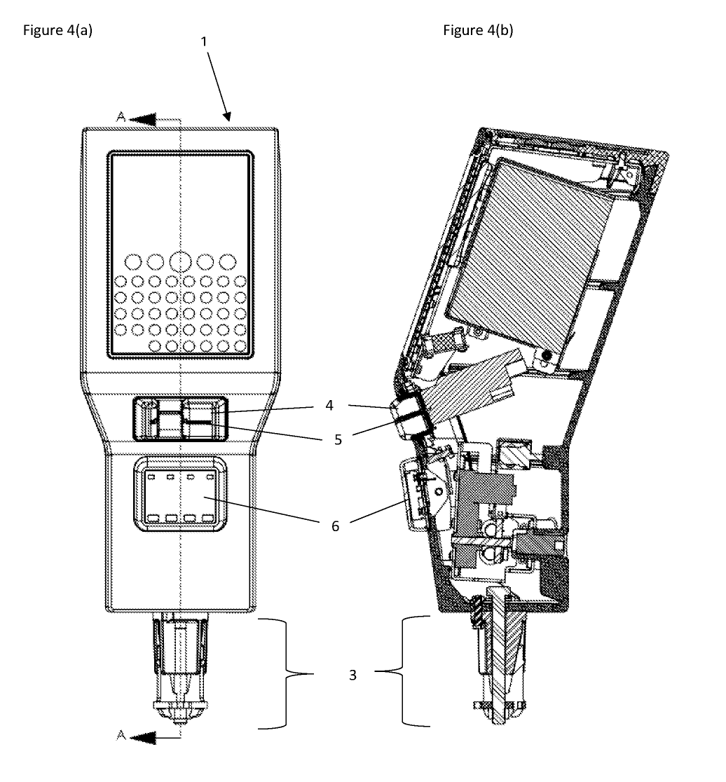

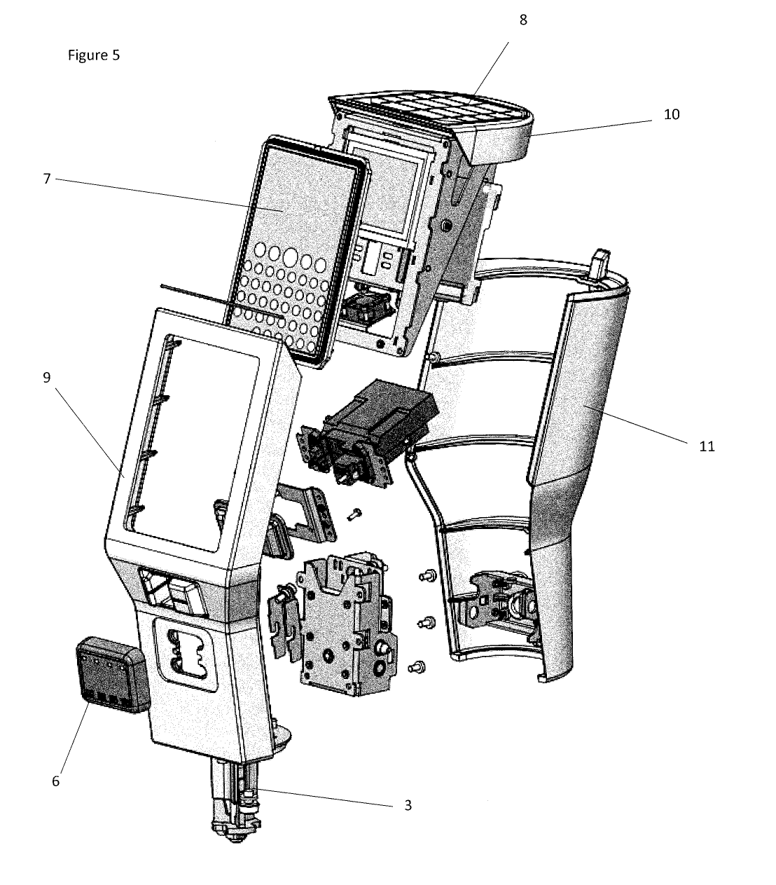

The parking meter device 1 includes a secure card reader mechanism 4, with a card access opening or slot 5 into which a credit card or debit card may be inserted to be read by a reading device 17 (see FIG. 3(b)), a contactless payment instrument reader 6 and a capacitive touch user interface 7, which includes a keypad 18, such as an alpha numeric or numeric keypad and a display 19. The parking meter device 1 also includes a solar panel 8, such as a 2.5 W solar panel, located on its top surface.

With reference to FIG. 2(c), the parking meter device 1 comprises a three-piece corrosion resistant chassis, preferably made from aluminium, comprising front cover 9, top cover 10 and rear cover 11. Also shown are a pair of light emitting diodes (LED) 12 that provide visual indicators as to the status of the parking meter device 1, such as whether the paid period remains current, or the paid period has expired. For example, a red LED may be provided along with a green LED to indicate whether the paid for parking period has expired or not. In use these LED's may be illuminated in a flashing manner or simply in an on or off mode.

Access to the inner workings of the parking device meter 1 is through the barrel lock 13. The opening of this lock removes the rear cover 11.

With reference to FIGS. 3(a) to 3(d), the rear cover 11 has been removed to show the components within the parking meter device 1; such as a main rechargeable, replaceable battery 14, a central process controller 15 and an auxilliary process controller 16,—the process controllers controlling the processes within the device.

With reference to FIGS. 4(a), and in particular 4(b) where a cross-sectional view is shown, the components within the parking meter device 1 can be seen as shown in FIGS. 3(a)-3(d) along with a locking system 16 for locking the rear cover to the device.

An infrared receiver and transmitter may be included whereby management data and operational software may be transferred to and from a portable communication device (not shown).

Thus, the parking meter device 1 includes the card reading device 4 and contactless card reader 6, the display 19, the keypad 18, and the solar panel 8 referred to above. In addition there is a power management facility, the rechargeable, replaceable battery 14, random access memory, the central controller 15 (which includes a clock chip to control time, flash memory for code, a contactless card reader), a card reader interface for cards having chips and magnetic strips, input/output I/O hardware, sensors, switches and reset, one or more LED indicators 12, a display driver for the display, a communications subsystem, a cellular phone engine with its antenna, a Wi-Fi engine and its antenna, a GPS unit and its antenna; a camera system for recording vehicle number plates or occupancy of one or more proximate parking bays.

The central process controller 15 controls operation and the timing means of the parking meter device 1. The meter time may also synchronise with an online server periodically to ensure synchronicity with real time. An integrated device is used, providing RAM, ROM, and some I/O capabilities. Power down features are of importance when selecting the central process controller 15, as the parking meter device 1 is typically in the idle or sleep mode.

To minimise power consumption, power management circuitry is provided to allow application of power to only the necessary peripherals at only the necessary times. The power management facility also provides battery status to the central process controller 15 to allow changes in operation based on available power, as well as reporting to the management system.

The parking meter device contains a number of switches such as touch keys for user input, presence detection in the card reader, and door switches. The I/O hardware allows the microcontroller to sense the state of the switches.

The following types of information will be displayed on the display: what parking bay has been paid for, the time period till expiry, licence plate, current date and time, payment amount, electronic receipt number, electronic receipt web download address, ICONS, LOGOS, meter operator name, (e.g. City Council), meter ID, help screen text, time selection fuel guage and directions to the closest cash meter.

In use, a vehicle operator wanting to occupy a parking bay will approach the parking meter device 1 and enter the bay number or vehicle licence plate details, then insert either a card into the meter 1 or position a card, smart phone, or smart watch near to the contactless card reader. The contactless card reader accepts NFC (near field communications) transactions or HCE (host card emulations) transactions from a payment instrument having the necessary chip componentry. Either method will wake up the electronic componentry of the parking meter device 1 and the meter 1 will then validate the payment instrument. By inserting a card and manipulating the controls on the touch pad the vehicle operator can determine the amount of parking time the operator wishes to purchase. The amount of time purchased is then displayed on the electronic display. The parking meter device will communicate with the credit card company wirelessly and authorise the payment using that card.

An alternative method of payment may be through a smart phone application, whereby the smart phone can communicate through an application and GPS location with a specific parking meter and deduct payment from the smart phone. Similarly, if the user, once having walked away from the parking meter device wishes to top-up the payment and extend the period of paid parking, the user may access the smart phone app and top-up the paid period balance on the parking meter device or the pay by plate or pay by space optionality.

A parking meter device management system may be used to manage a number of parking devices. Such a web based management system is the cloud based central management system called Ezicom2 provided by Global Parking Solutions—see www.global parking solutions.com. Ezicom2 pulls all the parking information from one or more parking meter devices to enable a parking warden, a vehicle user or control centre to see what is happening in real time on any web-connected desktop, tablet or smart device. Such a management system means that parking wardens can identify the expired parking spaces or if the parking meter device is fitted with a camera, those parking spaces that are occupied and for which no payment of any type has been received.

### ADVANTAGES

The advantages of the aspects and embodiments provided by the parking meter device of this invention include the provision of a ticketless and coinless parking meter device. These features allow for devices that do not require semi-regular visiting by personnel to remove the coins from the device or to re-charge the paper roll for dispensing tickets and saves on the use of consumables and lower maintenance and service costs. The ticketless feature of the parking device also means that there are no ticket jams. A further advantage is that the device uses solar power to power its functions. Another advantage is that the parking meter device can be retrofitted onto existing parking meter stands and can be installed for single parking bay metering or multiple parking bay metering.

Another advantage is that the use of a web based management system may be used. Such a web based management system is the cloud based central management system Ezicom2, which pulls all the parking information from one or more parking meter devices to enable a parking warden, a vehicle user or control centre to see what is happening in real time on any web-connected desktop, tablet or smart device.

A significant vehicle user advantage is that the user does not need to return to the vehicle to display a ticket. The parking meter device may be topped up for a plate or a space either through a smart phone app or by sending a SMS message or the like.

The present invention and its embodiments have been described in detail. However, the scope of the present invention is not intended to be limited to the particular embodiments of the invention described in the specification. Various modifications, substitutions, and variations can be made to the disclosed material without departing from the spirit and/or essential characteristics of the present invention. Accordingly, one of ordinary skill in the art will readily appreciate from the disclosure that later modifications, substitutions, and/or variations performing substantially the same function or achieving substantially the same result as embodiments described herein may be utilised according to such related embodiments of the present invention. Thus, the following claims are intended to encompass within their scope modifications, substitutions, and variations to the embodiments of the invention disclosed.

1. A compact, coinless, ticketless parking meter device which is adapted to control parking at a single parking bay and at multiple parking bays, and which includes
a timer means;
a payment facilitating arrangement operable in cooperation with a non-cash payment instrument for effecting payment of a monetary amount for a parking period;
a display means for displaying a balance remaining of the parking period;
a power supply unit for supplying power to the timer means, the payment facilitating arrangement and the display means;
a central information management system to store and transmitrealtime parking device information from one or moreof said parking meter device.

2. The parking meter device according to claim 1, wherein (i) the payment facilitating arrangement is a card reading means, for reading information and data on the card which has a magnetic strip or a chip; (ii) the payment facilitating arrangement has a wireless banking information transmitting means for transmitting financial transaction data to a banking system in order to debit the appropriate account, as determined from the card, and credit the account of the parking operator; or (iii) the payment facilitating arrangement has a wireless purse communicating means for communicating with an electronic purse, whereby an appropriate amount may be deducted from the value stored in the purse, and the banking information transmitting means is then operable to credit the account of the parking operator with the amount by which the purse was decreased.

3. The parking meter device according to claim 42, wherein (i) the card reading means is a contactless card reader; or (ii) the card reading means is a card reader having an access slot into which the card is inserted to read the information and data on the card.

4. The parking meter device according to claim 1, wherein the timer means is a clock chip, which is included in a central process controller.

5. (canceled)

6. The parking meter device according to claim 1, further including one or more of: (i) an alpha-numeric or numeric keypad; (ii) a camera positioned to take photos of a proximate parking bay; (iii) indicator means that show the status of the device; (iv) a payment facilitating arrangement for receiving an instruction and payment from a cellular telephone; (v) a solar power charging arrangement whereby the power supply unit is recharged by solar energy; (vi) a power management facility; (vii) a locating arrangement for determining the location of the parking meter device; or (viii) a selection means for selecting the duration of parking time required and the appropriate cost thereof, whereby a person wishing to park may select the desired time duration.

7. The parking meter device according to claim 3, wherein the card reader has an access slot into which the card is inserted to read the information and data on the card.

8. (canceled)

9. The parking meter device according to claim 1, adapted for use in a multi-parking bay situation and including pay by space or pay by car number plate functionality.

10. The parking meter device according to claim 1, wherein the power supply unit sources power from a solar panel.

11. (canceled)

12. The parking meter device according to claim 6, wherein the indicator means is one or more light emitting diodes.

13. (canceled)

14. The parking meter device according to claim 2, wherein the banking information transmitting means operate in an on-line or off-line manner; or (ii) the banking information transmitting means uses a cellular telephone network or Wi-Fi and IP Embedded Wireless.

15. -20. (canceled)

21. The parking meter device according to claim 6, wherein the locating arrangement is GPS operable.

22. The parking meter device according to claim 1, wherein the central information management system communicates the parking device information to a vehicle user, a management centre or a parking warden.

23. The parking meter device according to claim 22, wherein the parking device information includes at least one of: parking time remaining, parking time exceeded, malfunction details, a tampering alert, and the location of the parking meter device.

24. The parking meter device according to claim 1, wherein the display means is adapted to display that parking time paid for has expired.

25. (canceled)

26. A method of controlling parking in a single parking bay or multiple parking bays, which includes accepting payment for parking in at least one parking bay by means of a credit or debit card account, from an electronic purse, or by means of a cellular telephone using the parking device according to claim 1.

27. A method according to claim 26, in which, (i) if payment is effected by means of a credit or debit card account, the method includes transmitting data in a wireless manner to a first financial institution to debit an account of the parker and a second financial institution to credit the account of a parking operator (ii); if payment is effected from an electronic purse, the method includes transmitting financial data in a wireless manner with the first financial institution to debit an account of the purse administrator and with the second financial institution to credit the account of the parking operator; or (iii) if payment is effected by means of a cellular telephone, the method includes receiving an authorisation signal that payment for the parking has been made.

28. -29. (canceled)

30. A method according to claim 27, in which, the authorisation signal is provided by the second financial institution or from a control centre.

31. A method according to claim 26, which includes sensing if a vehicle is parked in the bay when the paid for parking time has expired or the maximum parking time has been exceeded and transmitting a time expired signal to a management centre or a parking warden.

32. A method according to claim 31, in which a location signal, providing the location of the bay, is transmitted.
